(19) United States
(12) Patent Application Publication
(10) Pub. No.: US 2016/0274749 A1
(43) Pub. Date: Sep. 22, 2016

(54) TERMINAL CONTROL METHOD AND TERMINAL CONTROL DEVICE

(71) Applicant: Yulong Computer Telecommunication Scientific (Shenzhen) Co., Ltd., Shenzhen (CN)

(72) Inventors: Hangui Li, Shenzhen (CN); Kuan Zou, Shenzhen (CN); Feng Liu, Shenzhen (CN)

(21) Appl. No.: 15/171,218

(22) Filed: Jun. 2, 2016

Related U.S. Application Data
(63) Continuation of application No. PCT/CN2014/070636, filed on Jan. 15, 2014.

(51) Int. Cl. G06F 3/0482; G06F 3/0481; G06F 3/0488; G06F 3/0484

(52) U.S. Cl. CPC G06F 3/0482; G06F 3/04842; G06F 3/04817; G06F 3/04845; G06F 3/04883; G06F 2203/04808

(57) ABSTRACT

The present disclosure provides a terminal control method and a terminal control device. The terminal control method includes: detecting multiple touch points formed on a screen interface; displaying a management interface of a hidden icon on the screen interface if at least one of the touch points slides to a first direction and at least one of the remaining touch points slides to a second direction opposite to the first direction. In the technical solution of the present disclosure, by detecting the movement tracks of the multiple touch points on the screen interface of the terminal, the management interface of the hidden icon can be opened quickly without interface switching, and the operation can be convenient and efficient.

### CROSS-REFERENCE TO RELATED APPLICATIONS

This application is a continuation of application PCT/CN2014/070636, filed on Jan. 15, 2014, and entitled TERMINAL CONTROL METHOD AND TERMINAL CONTROL DEVICE, which disclosure is herein incorporated by reference.

### TECHNICAL FIELD

The present disclosure relates to the technical field of terminal control, and particularly to a terminal control method and a terminal control device.

### BACKGROUND

As more and more applications are introduced to mobile terminals, a user may not want to display application (in the figures, “App”) icons on the desktop after the installation of applications, and need to hide the application icons.

In the related art, the method used to hide application icons can be as follows: call up a function menu on the desktop and select “Hide Apps” (as shown in FIG. 1), and check the applications that need to be hidden on the application list interface shown in FIG. 2, so as to hide the icons of the selected applications.

However, in the above process of hiding application icons, it can be needed to switch interfaces repeatedly among desktop, function menu interface, and icon selecting interface, which makes the operation very complicated.

Thus, how to realize the hidden management of application icons quickly has become an urgent problem to be solved.

### SUMMARY

Based on the abovementioned problem, one aspect of the present disclosure provides a terminal control method, wherein by detecting the movement tracks of multiple touch points on the screen interface of a terminal, a management interface of hidden icons can be opened quickly without interface switching, and the operation can be convenient and efficient, thereby improving operational efficiency.

In view of this, the present disclosure provides a terminal control method, which comprises: detecting multiple touch points formed on a screen interface; and displaying a management interface of hidden icons on the screen interface if at least one of the touch points slides to a first direction and at least one of the remaining touch points slides to a second direction opposite to the first direction.

In this technical solution, by detecting the movement tracks of multiple touch points on the screen interface (that is, there are touch points which slide along opposite directions at the same time) and determining to display the management interface of hidden icons on the screen interface accordingly, there can be no need to switch interfaces repeatedly or to select corresponding function keys, and the operation can be convenient and efficient.

A hidden icon can be any application icon. As one preferred embodiment, the hidden icon can be the icon of a private application that the user does not want to be revealed, such as “Diary,” “Account Management,” etc. Through the management interface of hidden icons, the user can execute hiding or un-hiding on any application icon.

In the abovementioned technical solution, preferably, it further comprises: displaying the contents initially displayed on the screen interface in a first area, and displaying the management interface of hidden icons in a second area other than the first area on the screen interface.

In this technical solution, the contents initially displayed on the screen interface and the management interface of hidden icons can be displayed in the first area and the second area respectively, thus to determine directly whether an application icon has been hidden by checking the area in which the application icon is located. The application icon has not been hidden if this application icon is located in the first area; the application icon has been hidden if this application icon is located in the second area.

Meanwhile, by displaying the contents initially displayed and the management interface of hidden icons on the screen interface simultaneously, it makes the user easy to facilitate the interactions between the contents initially displayed and the management interface of hidden icons. For example, a hidden setting of an application icon of the contents initially displayed can be achieved by dragging the application icon into the management interface of hidden icons, or an un-hiding setting can be achieved by dragging the application icon along an opposite direction, thereby simplifying the operation process.

The contents initially displayed can include all of the contents initially displayed on the screen interface, and as a result, thumbnail display or deformation can be needed for the contents initially displayed (such as compressing the gap between icons); alternatively, the contents initially displayed can only include parts of the contents (such as only application icons are displayed), thereby avoiding thumbnail display, which makes the user convenient to view.

In the abovementioned technical solution, preferably, it further comprises: determining a display position of the first area or the second area on the screen interface according to the position information of the multiple touch points on the screen interface.

In this technical solution, when the user conduct operation via multiple touch points, since the positions of the multiple touch points are likely to be easier for the user to operate or view, it will be convenient for the user to further achieve the operation on the management interface of hidden icons when determining the display position of the first area or the second area based on the position information.

In the above technical solution, when displaying the first area or the second area according to the position information of the multiple touch points, as one preferred embodiment, the initial position of the multiple touch points can be included in the second area; as another preferred embodiment, the area formed when the multiple touch points slide along a first direction and a second direction can be deemed as the second area.

A person of ordinary skill in the art should be noted that, the display position of the management interface of hidden icons can be arbitrary, and there can be many other specific methods for determining the display position; therefore, the explanation herein is not intended to be a specific limitation.

In the abovementioned technical solution, preferably, it further comprises: if any application icon in the first area is dragged into the second area, setting the application icon being dragged into the second area to be a hidden icon from a non-hidden icon; and/or, if any application icon in the second area is dragged into the first area, setting the application icon being dragged into the first area to be a non-hidden icon from a hidden icon.

In this technical solution, the display area of initial icons of the screen interface can be the first area, and the display area of the management interface of hidden icons can be the second area. Since the above two areas can be displayed on the screen interface of the terminal simultaneously, the hidden or non-hidden setting of application icons can be achieved by the dragging thereof; therefore, the operation can be convenient and efficient, thereby improving operational efficiency.

In the abovementioned technical solution, preferably, it further comprises: if any application icon is dragged into the first area or the second area, rearranging the application icons in the first area and the second area according to a predetermined sequence.

In this technical solution, after the application icon being dragged into the first area or the second area, the display position occupied by the application icon originally will be free, thus causing waste of the display space and disorder of the icon arrangement. Therefore, the free position appeared after the movement of the application icon will be filled in time by rearranging the icons in the first area and the second area, without the need to arrange the icons manually by the user. In this technical solution, the predetermined sequence of the arrangement of icons can be any one of the following or a combination thereof: the first letter of the name, the time of installation, and the frequency of use, etc.

In the abovementioned technical solution, preferably, when any application icon is dragged to a target position in the first area or the second area, it further comprises: determining an application icon corresponding to the target position in order for said any application icon to occupy a corresponding display position of the determined application icon, and rearranging other application icons that arranged after the corresponding display position; wherein, if the target position corresponds to a plurality of application icons, the application icon arranged at the end will be deemed as the corresponding application icon.

In this technical solution, by determining whether there is an application icon in the target position and performing rearrangement after the dragging of an icon, the user can select the display position of the application icon currently being dragged according to needs, and affect the original application icon arrangement as little as possible.

In this technical solution, if the target position corresponds to a plurality of application icons, the application icon arranged at the end will be determined according to a predetermined arrangement sequence of the terminal. For instance, as a preferred embodiment, the arrangement sequence can be as follows: in the horizontal direction, the order of arrangement of the application icons on the left side can be higher than that of the application icons on the right side; in the vertical direction, the order of arrangement of the application icons on the upper side can be higher than that of the application icons on the lower side.

In any of the abovementioned technical solutions, preferably, the touch points can be located in the gap between application icons on the screen interface. By making the touch points in the gap between application icons, erroneous operation due to the overlapping of the touch points and application icons can be avoided, which can be helpful to improve the accuracy of operation.

According to another aspect of the present disclosure, it can be provided a terminal control device, which comprises: a touch point detecting unit, configured to detect multiple touch points formed on a screen interface of a terminal; a slide determining unit, configured to determine whether at least one of the touch points slides to a first direction and at least one of the remaining touch points slides to a second direction opposite to the first direction; and an interface displaying unit, configured to display a management interface of hidden icons on the screen interface if the determination result of the slide determining unit is yes.

In this technical solution, by detecting the movement tracks of multiple touch points on the screen interface (that is, there are touch points which slide along opposite directions) and determining the management interface of hidden icons displayed on the screen interface accordingly, there can be no need to switch interfaces repeatedly and to select corresponding function keys, and the operation can be convenient and efficient.

A hidden icon can be any application icon. As one preferred embodiment, the hidden icon can be the icon of a private application that the user does not want to be revealed, such as “Diary,” “Account Management,” etc. Through the management interface of hidden icons, the user can execute hiding or un-hiding on any application icon.

In the abovementioned technical solution, preferably, the interface displaying unit can be configured to: display the contents initially displayed on the screen interface in a first area, and display the management interface of hidden icons in a second area other than the first area on the screen interface.

In this technical solution, the contents initially displayed on the screen interface and the management interface of hidden icons can be displayed in the first area and the second area respectively, thus to determine directly whether an application icon has been hidden by checking the area in which the application icon is located. The application icon has not been hidden if this application icon is located in the first area; the application icon has been hidden if this application icon is located in the second area.

Meanwhile, by displaying the contents initially displayed and the management interface of hidden icons on the screen interface simultaneously, it makes the user easy to facilitate the interactions between the contents initially displayed and the management interface of hidden icons. For example, a hidden setting of an application icon of the contents initially displayed can be achieved by dragging the application icon into the management interface of hidden icons, or an un-hiding setting can be achieved by dragging the application icon along an opposite direction, thereby simplifying the operation process.

The contents initially displayed can include all of the contents initially displayed on the screen interface, and as a result, thumbnail display or deformation can be needed for the contents initially displayed (such as compressing the gap between icons); alternatively, the contents initially displayed can only include parts of the contents (such as displaying application icons only), thereby avoiding thumbnail display, which makes the user convenient to view.

In the abovementioned technical solution, preferably, it further comprises: a position determining unit, configured to determine a display position of the first area or the second area on the screen interface according to the position information of the multiple touch points on the screen interface, whereby the interface displaying unit will display the first area and the second area.

In this technical solution, when the user conduct operation via multiple touch points, since the positions of the multiple touch points are likely to be easier for the user to operate or view, it will be convenient for the user to further achieve the operation on the management interface of hidden icons when determining the display position of the first area or the second area based on the position information.

In the above technical solution, when displaying the first area or the second area according to the position information of the multiple touch points, as one preferred embodiment, the initial position of the multiple touch points can be included in the second area; as another preferred embodiment, the area formed when the multiple touch points slide along a first direction and a second direction can be deemed as the second area.

A person of ordinary skill in the art should be noted that, the display position of the management interface of hidden icons can be arbitrary, and there can be many other specific methods for determining the display position; therefore, the explanation herein is not intended to be a specific limitation.

In the abovementioned technical solution, preferably, it further comprises: a hiding setting unit, configured to set the application icon being dragged into the second area to be a hidden icon from a non-hidden icon if any application icon in the first area is dragged into the second area; and/or, set the application icon being dragged into the first area to be a non-hidden icon from a hidden icon if any application icon in the second area is dragged into the first area.

In this technical solution, the display area of initial icons of the screen interface can be the first area, and the display area of the management interface of hidden icons can be the second area. Since the above two areas can be displayed on the screen interface of the terminal simultaneously, the hidden or non-hidden setting of application icons can be achieved by the dragging thereof; therefore, the operation can be convenient and efficient, thereby improving operational efficiency.

In the abovementioned technical solution, preferably, it further comprises: an icon arranging unit, configured to rearrange the application icons in the first area and the second area according to a predetermined sequence if any application icon is dragged into the first area or the second area.

In this technical solution, after the application icon being dragged into the first area or the second area, the display position occupied by the application icon originally will be free, thus causing waste of the display space and disorder of the icon arrangement. Therefore, the free position appeared after the movement of the application icon will be filled in time by rearranging the icons in the first area and the second area, without the need to arrange the icons manually by the user. In this technical solution, the predetermined sequence of the arrangement of icons can be any one of the following or a combination thereof: the first letter of the name, the time of installation, and the frequency of use, etc.

In the abovementioned technical solution, preferably, it further comprises: an icon determining unit, configured to, when any application icon is dragged to a target position in the first area or the second area, determine an application icon corresponding to the target position in order for said any application icon to occupy a corresponding display position of the determined application icon; wherein, if the target position corresponds to a plurality of application icons, take the application icon arranged at the end as the corresponding application icon; wherein, the icon arranging unit can be configured to rearrange other application icons that arranged after the corresponding display position.

In this technical solution, by determining whether there is an application icon in the target position and rearranging after the dragging of the icon, the user can select the display position of the application icon currently being dragged according to needs, and affect the original application icon arrangement as little as possible.

In this technical solution, if the target position corresponds to a plurality of application icons, the application icon arranged at the end will be determined according to a predetermined arrangement sequence of the terminal. For instance, as a preferred embodiment, the arrangement sequence can be as follows: in the horizontal direction, the order of arrangement of the application icons on the left side can be higher than that of the application icons on the right side; in the vertical direction, the order of arrangement of the application icons on the upper side can be higher than that of the application icons on the lower side.

In any of the abovementioned technical solutions, preferably, the touch points can be located in the gap between application icons on the screen interface. By making the touch points in the gap between application icons, erroneous operation due to the overlapping of the touch points and application icons can be avoided, which can be helpful to improve the accuracy of operation.

According to a further aspect of the disclosure, it can be further provided a program product stored in a non-volatile machine readable medium for terminal control. The program product includes machine executable instructions, when executed by a computer system, causing the system to execute the following operations: detecting multiple touch points formed on a screen interface; displaying a management interface of hidden icons on the screen interface if at least one of the touch points slides to a first direction and at least one of the remaining touch points slides to a second direction opposite to the first direction.

According to a further aspect of the disclosure, it can be further provided a non-volatile machine readable medium storing a program product for terminal control. The program product includes machine executable instructions, when executed by a computer system, causing the system to execute the following operations: detecting multiple touch points formed on a screen interface; displaying a management interface of hidden icons on the screen interface if at least one of the touch points slides to a first direction and at least one of the remaining touch points slides to a second direction opposite to the first direction.

According to a further aspect of the disclosure, it can be further provided a machine-readable program, configured to cause the machine to execute any of the terminal control methods described in the abovementioned technical solutions.

According to a further aspect of the disclosure, it can be further provided a storage medium storing a machine-readable program. The machine-readable program can be configured to cause the machine to execute any of the terminal control methods described in the abovementioned technical solutions.

By means of the abovementioned technical solution, the management interface of hidden icons can be opened quickly without interface switching, and the operation can be convenient and efficient.

### BRIEF DESCRIPTION OF THE DRAWINGS

FIG. 1 is a schematic view illustrating an interface of clicking the icon of “Hide Apps” in the related art.

FIG. 2 is a schematic view illustrating an interface of searching the applications to be hidden in the related art.

FIG. 3 is a flow chart illustrating a terminal control method in accordance with one embodiment of the disclosure.

FIG. 4A-4E are schematic views illustrating an interface of hiding or un-hiding application icons according to a gesture in accordance with one embodiment of the disclosure.

FIG. 5 is a specific flow chart illustrating the process of hiding application icons in accordance with one embodiment of the disclosure.

FIG. 6 is a specific flow chart illustrating the process of un-hiding application icons in accordance with one embodiment of the disclosure.

FIG. 7 is a block diagram illustrating a terminal control device in accordance with one embodiment of the disclosure.

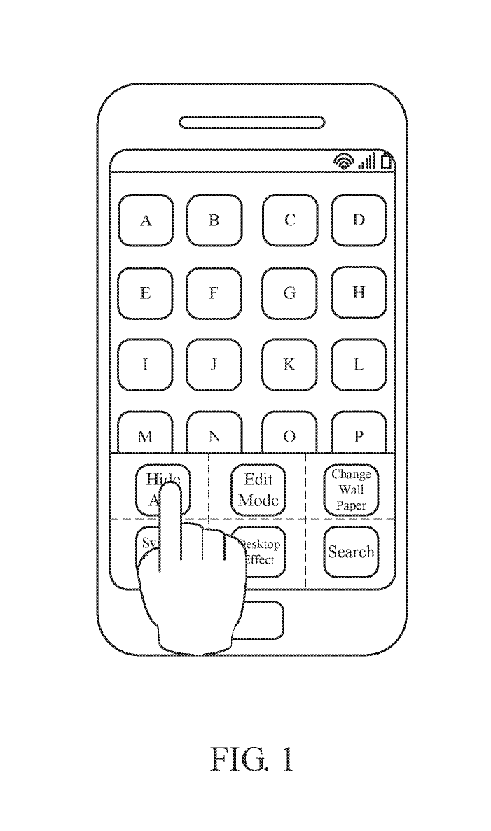

### DETAILED DESCRIPTION

To understand the above-mentioned purposes, features, and advantages of the present disclosure more clearly, the present disclosure will be further described in detail below in combination with the accompanying drawings and the specific implementations. It should be noted that, the embodiments of the present application and the features in the embodiments can be combined with one another without conflicts.

Many specific details will be described below for sufficiently understanding the present disclosure. However, the present disclosure can also be implemented by adopting other manners different from those described herein. Accordingly, the protection scope of the present disclosure is not limited by the specific embodiments disclosed below.

I. The Calling of an Interface

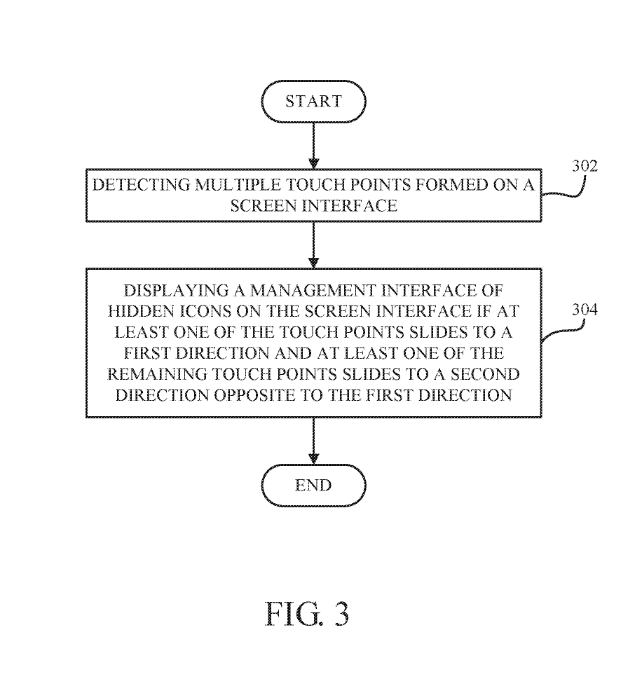

FIG. 3 is a flow chart illustrating a terminal control method in accordance with one embodiment of the disclosure.

As shown in FIG. 3, the terminal control method in accordance with one embodiment of the disclosure comprises: operation 302, detecting multiple touch points formed on a screen interface; operation 304, displaying a management interface of hidden icons on the screen interface if at least one of the touch points slides to a first direction and at least one of the remaining touch points slides to a second direction opposite to the first direction.

In this technical solution, by detecting the movement tracks of multiple touch points on the screen interface (that is, there are touch points which slide along opposite directions) and determining the management interface of hidden icons displayed on the screen interface accordingly, there can be no need to switch interfaces repeatedly and to select corresponding function keys, and the operation can be convenient and efficient.

A hidden icon can be any application icon. As one preferred embodiment, the hidden icon can be the icon of a private application that the user does not want to be revealed, such as “Diary,” “Account Management,” etc. Through the management interface of hidden icons, the user can execute hiding or un-hiding on any application icon.

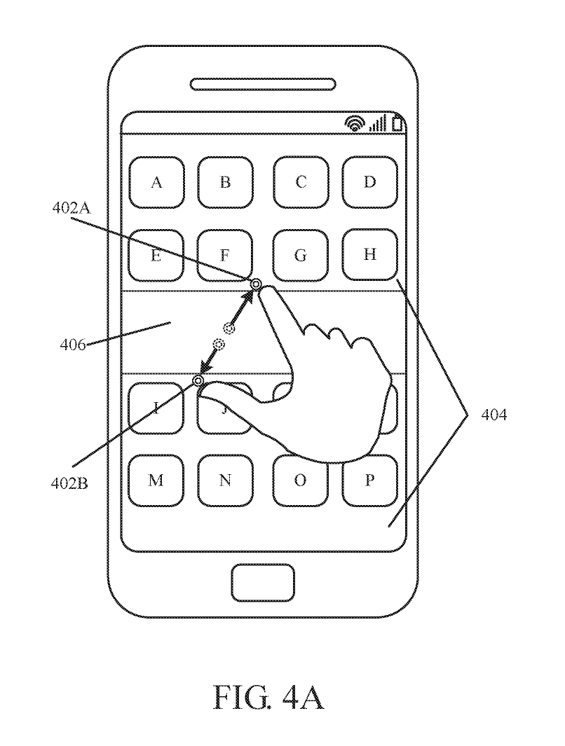

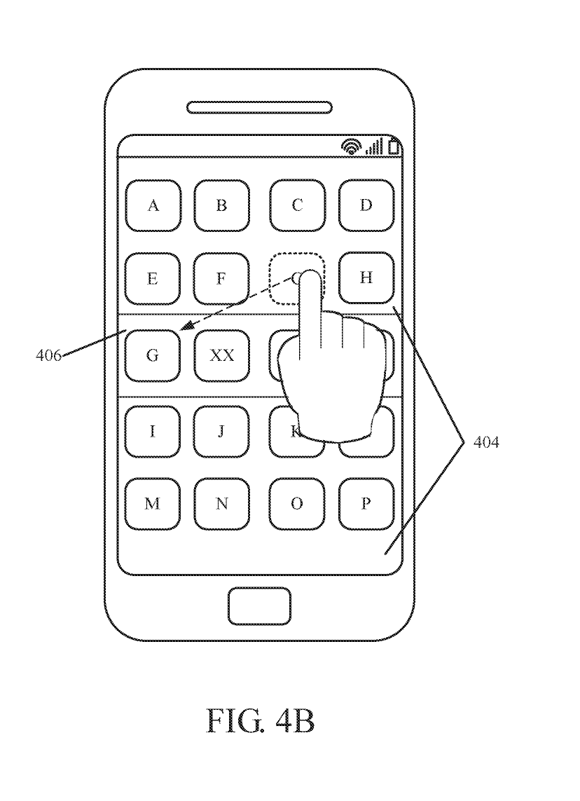

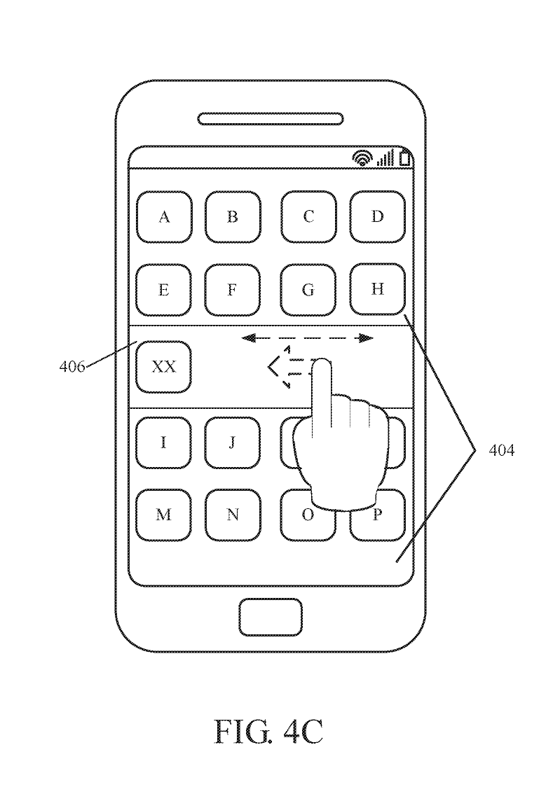

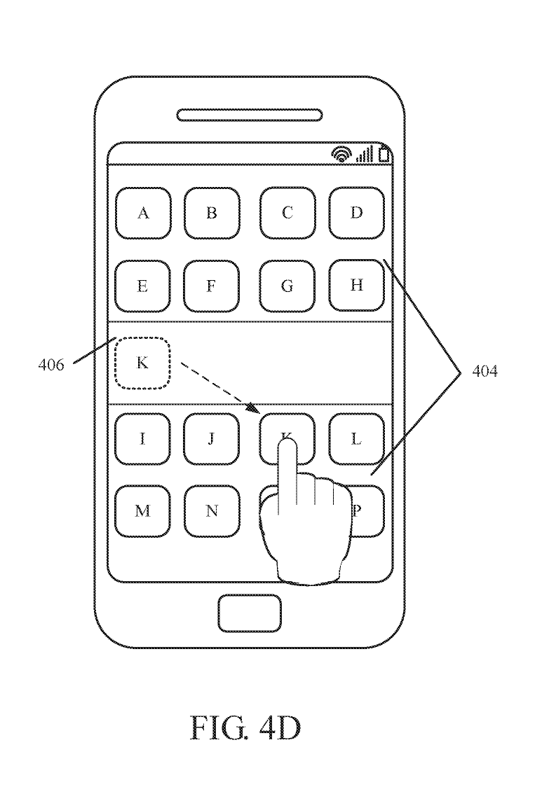

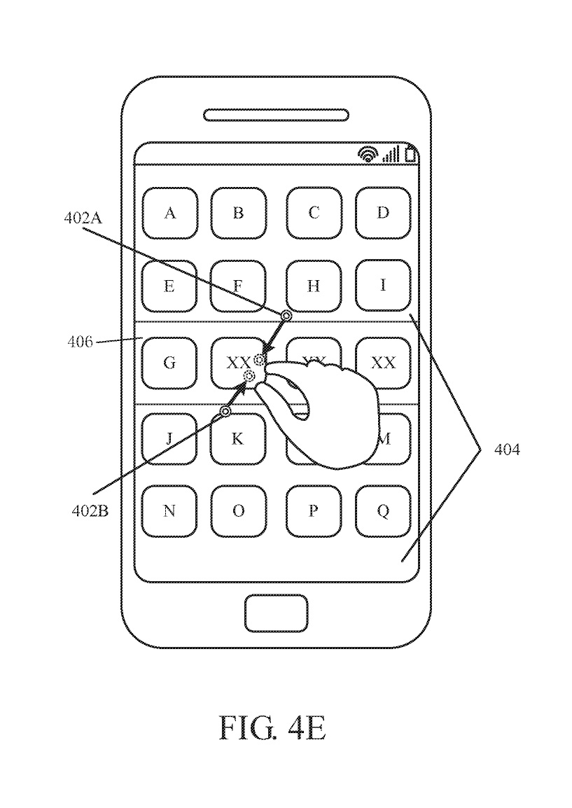

As one specific application scenario, FIG. 4A illustrates a specific situation that two fingers of the user slide in opposite directions to open the management interface of hidden icons.

As shown in FIG. 4A, it can be supposed that two touch points are formed on the screen interface of the terminal with two fingers of the user, that is, a touch point 402A and a touch point 402B. If the touch point 402A and the touch point 402B slide in opposite directions, for instance, the touch point 402A slides upward and the touch point 402B slides downward, the management interface of hidden icons will be called up on the screen interface of the terminal without interface switching, and the operation can be convenient and efficient.

Preferably, in FIG. 4A, the contents initially displayed on the screen interface can be displayed in a first area 404, and the management interface of hidden icons can be displayed in a second area 406 other than the first area 404 on the screen interface.

In this technical solution, the contents initially displayed on the screen interface and the management interface of hidden icons can be displayed in the first area 404 and the second area 406 respectively, thereby determining directly whether an application icon has been hidden by checking the area in which the application icon is located. The application icon has not been hidden if this application icon is located in the first area 404; the application icon has been hidden if this application icon is located in the second area 406.

Preferably, this technical solution further comprises: determining a display position of the first area 404 or the second area 406 on the screen interface according to the position information of the multiple touch points (such as the touch point 402A and the touch point 402B, etc.) on the screen interface.

In this technical solution, when the user conduct operation via multiple touch points, since the positions of the multiple touch points are likely to be easier for the user to operate or view, it will be convenient for the user to further achieve the operation on the management interface of hidden icons when determining the display position of the first area 404 or the second area 406 based on the position information.

In the above technical solution, when displaying the first area or the second area according to the position information of the multiple touch points, a number of different methods can be used.

As one preferred embodiment, the initial positions of the multiple touch points can be included in the second area 406. Specially, for example, the initial positions (illustrated by dotted lines) of the touch point 402A and the touch point 402b can be included in the second area 406 of FIG. 4A.

As another preferred embodiment, an area formed when the multiple touch points slide along a first direction and a second direction can be deemed as the second area 406. Specially, such as in FIG. 4A, the upper and lower frames of the second area 406 correspond to the final positions (illustrated by solid lines) of the touch point 402A and the touch point 402B respectively. Moreover, the upper and lower frames of the second area 406 can slide along with the touch point 402A and the touch point 402B to achieve dynamic position change in the vertical direction, as if the user has “expanded” the second area 406 with fingers.

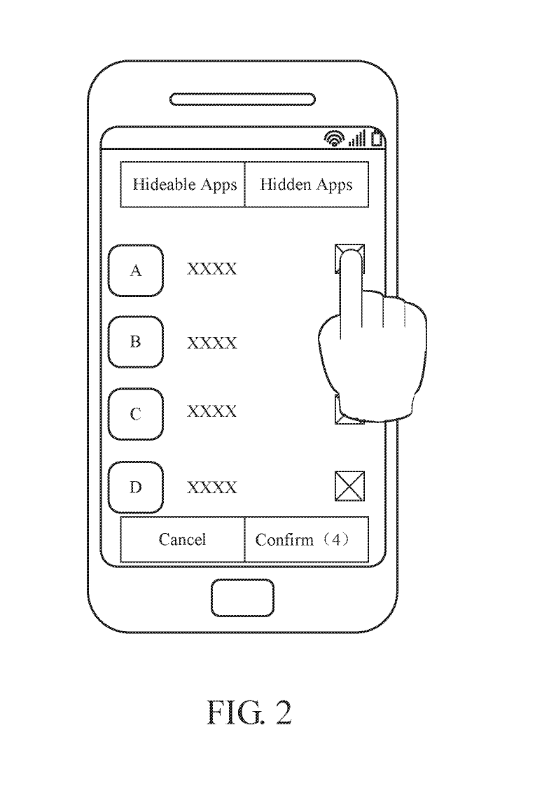

First, FIG. 4A illustrates the embodiment in which the first area 404 and the second area 406 can be displayed on the screen interface of the terminal simultaneously. A person of ordinary skill in the art will understand that, it can also be possible to only display the management interface of hidden icons on the screen interface through the sliding of multiple touch points, which is equivalent to the display state as shown in FIG. 2.

Second, in the first area 404 as illustrated in FIG. 4A, the contents initially displayed can include all of the contents initially displayed on the screen interface, and as a result, thumbnail display or deformation can be needed for the contents initially displayed (such as compressing the gap between icons); alternatively, the contents initially displayed can only include parts of the contents (such as only application icons are displayed), thereby avoiding thumbnail display, which makes the user convenient to view.

II. The Hiding of Icons

By displaying the first area 404 and the second area 406 simultaneously, that is, by displaying the contents initially displayed and the management interface of hidden icons on the screen interface simultaneously, it makes the user easy to facilitate the interactions between the contents initially displayed and the management interface of hidden icons.

For instance, in this technical solution, preferably, it further comprises: if any application icon in the first area 404 is dragged into the second area 406, setting the application icon being dragged into the second area 406 to be a hidden icon from a non-hidden icon.

In this technical solution, the display area of initial icons of the screen interface can be the first area 404, and the display area of the management interface of hidden icons can be the second area 406. Since the above two areas can be displayed on the screen interface of the terminal simultaneously, the hidden or non-hidden setting of application icons can be achieved by the dragging thereof; therefore, the operation can be convenient and efficient, thereby improving operational efficiency.

To be more specific, FIG. 4B is a schematic view illustrating an interface of dragging an application icon to a management interface 402 of hidden icons for hiding.

As shown in FIG. 4B, when the management interface of hidden icons is displayed in the second area 406, the hiding of the icon of application G can be achieved directly by dragging the icon of application G directly to the management interface of hidden icons.

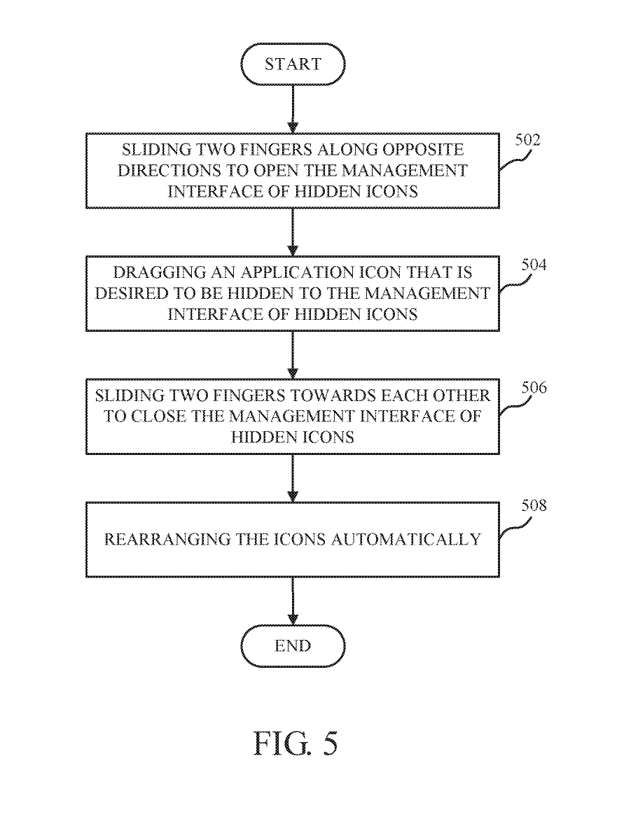

FIG. 5 is a specific flow chart illustrating the process of hiding application icons in accordance with one embodiment of the disclosure.

As shown in FIG. 5, the specific process of hiding application icons comprises:

Operation 502, sliding two fingers of the user along opposite directions to open the management interface of hidden icons on the desktop of the terminal.

Operation 504, dragging an application icon that is desired to be hidden to the management interface of hidden icons by the user to achieve the hiding of the application icon.

Operation 506, when the dragging of all the application icons that are desired to be hidden is completed, sliding two fingers of the user towards each other to close the management interface of hidden icons.

Operation 508, filling the blank of the hidden application icon with the next icon, and rearranging the icons on the desktop according to a predetermined rule.

III. The Selection of Icons

FIG. 4C is a schematic view illustrating an interface of sliding the fingers of the user left and right on the management interface of hidden icons.

As shown in FIG. 4C, on the management interface of hidden icons, not all of the hidden icons can be displayed on one screen because of the limited display space of the screen interface of the terminal. The hidden icons can be spread across multiple screens in order to facilitate the management of all the hidden icons; this enables the user to slide fingers left and right on the management interface of hidden icons to achieve the operation of flipping pages among multiple screens, therefore, the user can check any hidden icon and conduct management, such as deleting, un-hiding, etc.

IV. The Un-Hiding of Icons

In the embodiment illustrated in FIG. 4A, preferably, it may comprise: if any application icon in the second area 406 is dragged into the first area 404, setting the application icon being dragged into the first area 404 to be a non-hidden icon from a hidden icon.

Specifically, FIG. 4D is a schematic view illustrating an interface of dragging an application icon to achieve un-hiding.

As shown in FIG. 4D, on the management interface of hidden icons, application icon K, which is an icon that is desired to be hidden, has been found by the user, will be dragged directly to a target position in the first area 404 to achieve the un-hiding thereof.

In this technical solution, the display area of initial icons of the screen interface can be the first area 404, and the display area of the management interface of hidden icons can be the second area 406. Since the above two areas can be displayed on the screen interface of the terminal simultaneously, the hidden or non-hidden setting of application icons can be achieved by the dragging thereof; therefore, the operation can be convenient and efficient, thereby improving operational efficiency.

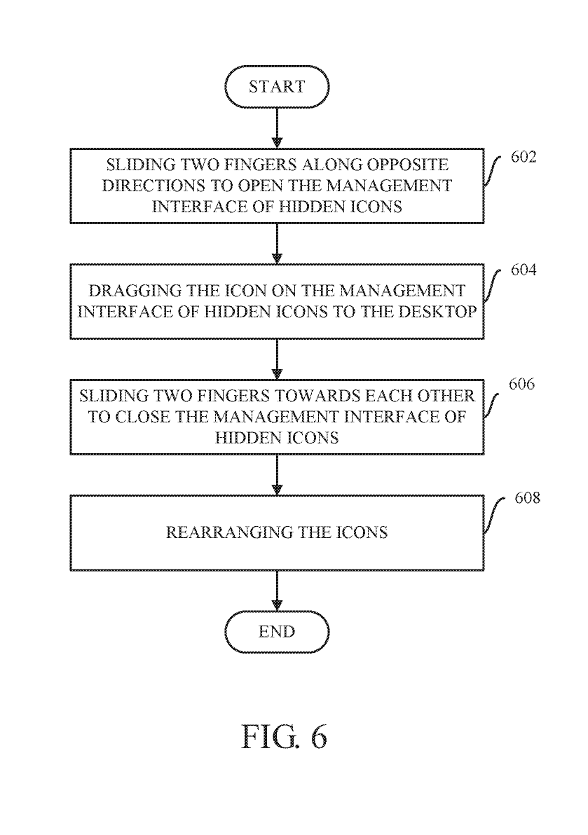

FIG. 6 is a specific flow chart illustrating the process of un-hiding application icons in accordance with one embodiment of the disclosure, wherein the process comprises:

Operation 602, sliding two fingers of the user along opposite directions to open the management interface of hidden icons on the desktop of the terminal.

Operation 604, dragging an application icon that can be desired to be non-hidden to the display area on the desktop by the user to achieve the un-hiding of the application icon.

Operation 606, when the dragging of all the application icons that are desired to be non-hidden is completed, sliding two fingers of the user towards each other to close the management interface of hidden icons.

Operation 608, the non-hidden application icon occupying the icon in the target position on the display area on the desktop; rearranging the icons on the desktop according to a predetermined rule.

V. The Arrangement of Icons

In the abovementioned technical solution, preferably, it further comprises: rearranging the application icons in the first area 404 and the second area 406 according to a predetermined sequence if any application icon can be dragged into the first area 404 or the second area 406.

In this technical solution, after the application icon being dragged into the first area 404 or the second area 406, the display position occupied by the application icon originally will be free, thus causing a waste of the display space and disorder of the icon arrangement. Therefore, the free position appeared after the movement of the application icon will be filled in time by rearranging the icons in the first area 404 and the second area 406, without the need to arrange the icons manually by the user.

To be more specific, the predetermined sequence of the arrangement of icons can be any one of the following or a combination thereof: the first letter of the name, the time of installation, and the frequency of use, etc.

For instance, as can be seen from the comparison of FIG. 4B and FIG. 4C, in FIG. 4B, the icon of application G has not yet been hidden; in FIG. 4C, the icon of application G has been hidden, and the remaining application icons in the first area 404 will be rearranged (in the figure, the remaining application icons on the interface of the terminal can be rearranged automatically according to the sequence of the first letter of the names of the applications).

Preferably, when any application icon is dragged to the target position in the first area 404 or the second area 406, it further comprises: determining an application icon corresponding to the target position in order for said any application icon to occupy a corresponding display position of the determined application icon, and rearranging other application icons that arranged after the corresponding display position; wherein, if the target position corresponds to a plurality of application icons, the application icon arranged at the end will be deemed as the corresponding application icon.

In this technical solution, by determining whether there is an application icon in the target position and performing rearrangement after the dragging of an icon, the user can select the display position of the application icon currently being dragged according to needs, and affect the original application icon arrangement as little as possible.

In this technical solution, if the target position corresponds to a plurality of application icons, the application icon arranged at the end will be determined according to a predetermined arrangement sequence of the terminal. For instance, as a preferred embodiment, the arrangement sequence can be as follows: in the horizontal direction, the order of arrangement of the application icons on the left side can be higher than that of the application icons on the right side; in the vertical direction, the order of arrangement of the application icons on the upper side can be higher than that of the application icons on the lower side.

Take FIG. 4D as an example, when the icon of application K is dragged to the first area 404, icon K will occupy the position of icon L if the target position of the dragging of icon K is the position of icon L, and icon L will move backward. The position of the icon that is arranged at the end will be selected as the target position of the dragging of icon K if the target position is an intermediate position between icon J and icon L; that is, the position of icon L will be selected as the target position, and icon K will occupy the position of icon L and icon L will move backward, thereby achieving the un-hiding of application K. The position of the icon that is arranged at the end will be selected as the target position of the dragging of icon K if the target position is an intermediate position among icon A, icon B, icon E, and icon F; that is, the position of icon F will be selected as the target position, and icon K will occupy the position of icon F and icon F will move backward, thereby achieving the un-hiding of application K.

VI. The Closure of the Interface

FIG. 4E is a schematic view illustrating an interface 402 of closing the management interface of hidden icons.

As illustrated in FIG. 4E, after the management operation of the management interface of hidden icons has been completed, as one preferred embodiment, the management interface of hidden icons can be closed by sliding two fingers of the user along opposite directions on the management interface of hidden icons, such as sliding the touch point 402A from upper right to lower left, and sliding the touch point 402B from lower left to upper right; then the second area 406 will disappear and the first area 404 will be displayed full screen.

With regard to the management interface of hidden icons, obviously there can also be other ways that can be used for the closure thereof, for example, click the blank area in the first area 404, click the “Return” button in the terminal, etc.

The controlling process on the screen of the terminal of the terminal control method in accordance with one embodiment of the present disclosure has been described in detail with reference to the drawings, it should be noted that, in any of the abovementioned technical solutions, as a preferred embodiment, all of the touch points can be located in the gap between application icons on the screen interface. By making the touch points in the gap between application icons, erroneous operation due to the overlapping of the touch points and application icons can be avoided, which can be helpful to improve the accuracy of operation.

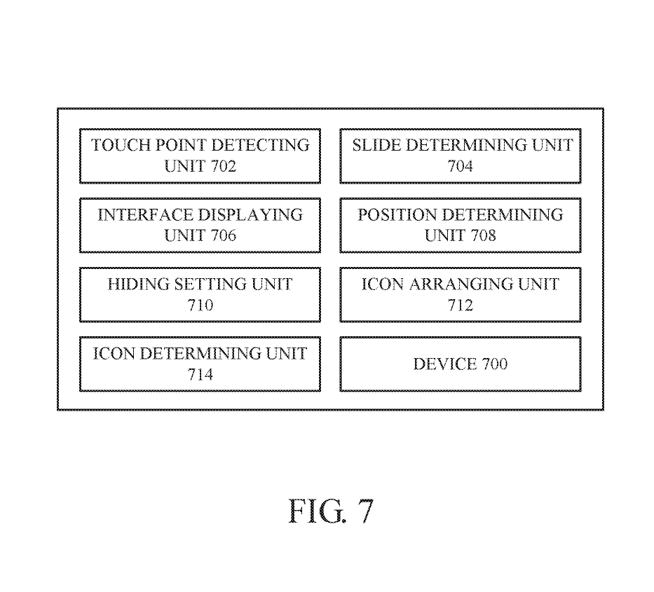

FIG. 7 is a block diagram illustrating a terminal control device in accordance with one embodiment of the disclosure.

As shown in FIG. 7, the terminal 700 in accordance with the embodiment of the disclosure comprises: a touch point detecting unit 702, configured to detect multiple touch points formed on a screen interface of a terminal; a slide determining unit 704, configured to determine whether at least one of the touch points slides to a first direction and at least one of the remaining touch points slides to a second direction opposite to the first direction; and an interface displaying unit 706, configured to display a management interface of hidden icons on the screen interface if the determination result of the slide determining unit 704 is yes.

In this technical solution, by detecting the movement tracks of multiple touch points on the screen interface (that is, there are touch points which slide along opposite directions) and determining the management interface of hidden icons displayed on the screen interface accordingly, there is no need to switch interfaces repeatedly and to select corresponding function keys, and the operation can be convenient and efficient.

A hidden icon can be any application icon. As one preferred embodiment, the hidden icon can be the icon of a private application that the user does not want to be revealed, such as “Diary,” “Account Management,” etc. Through the management interface of hidden icons, the user can execute hiding or un-hiding on any application icon.

In the abovementioned technical solution, preferably, the interface displaying unit 706 can be configured to: display the contents initially displayed on the screen interface in a first area, and display the management interface of hidden icons in a second area other than the first area on the screen interface.

In this technical solution, the contents initially displayed on the screen interface and the management interface of hidden icons can be displayed in the first area and the second area respectively, thus to determine directly whether an application icon has been hidden by checking the area in which the application icon is located. The application icon has not been hidden if this application icon is located in the first area; the application icon has been hidden if this application icon is located in the second area.

Meanwhile, by displaying the contents initially displayed and the management interface of hidden icons on the screen interface simultaneously, it makes the user easy to facilitate the interactions between the contents initially displayed and the management interface of hidden icons. For example, a hidden setting of an application icon of the contents initially displayed can be achieved by dragging the application icon into the management interface of hidden icons, or an un-hiding setting can be achieved by dragging the application icon along an opposite direction, thereby simplifying the operation process.

The contents initially displayed can include all of the contents initially displayed on the screen interface, and as a result, thumbnail display or deformation can be needed for the contents initially displayed (such as compressing the gap between icons); alternatively, the contents initially displayed can only include parts of the contents (such as displaying application icons only), thereby avoiding thumbnail display, which makes the user convenient to view.

In the abovementioned technical solution, preferably, it further comprises: a position determining unit 708, configured to determine a display position of the first area or the second area on the screen interface according to the position information of the multiple touch points on the screen interface, whereby the interface displaying unit will display the first area and the second area.

In this technical solution, when the user conduct operation via multiple touch points, since the positions of the multiple touch points are likely to be easier for the user to operate or view, it will be convenient for the user to further achieve the operation on the management interface of hidden icons when determining the display position of the first area or the second area based on the position information.

In the above technical solution, when displaying the first area or the second area according to the position information of the multiple touch points, as one preferred embodiment, the initial position of the multiple touch points can be included in the second area; as another preferred embodiment, the area formed when the multiple touch points slide along a first direction and a second direction can be deemed as the second area.

A person of ordinary skill in the art should be noted that, the display position of the management interface of hidden icons can be arbitrary, and there can be many other specific methods for determining the display position; therefore, the explanation herein is not intended to be a specific limitation.

In the abovementioned technical solution, preferably, it further comprises: a hiding setting unit 710, configured to set the application icon being dragged into the second area to be a hidden icon from a non-hidden icon if any application icon in the first area is dragged into the second area; and/or, set the application icon being dragged into the first area to be a non-hidden icon from a hidden icon if any application icon in the second area is dragged into the first area.

In this technical solution, the display area of initial icons of the screen interface can be the first area, and the display area of the management interface of hidden icons can be the second area. Since the above two areas can be displayed on the screen interface of the terminal simultaneously, the hidden or non-hidden setting of application icons can be achieved by the dragging thereof; therefore, the operation can be convenient and efficient, thereby improving operational efficiency.

In the abovementioned technical solution, preferably, it further comprises: an icon arranging unit 712, configured to rearrange the application icons in the first area and the second area according to a predetermined sequence if any application icon is dragged into the first area or the second area.

In this technical solution, after the application icon being dragged into the first area or the second area, the display position occupied by the application icon originally will be free, thus causing waste of the display space and disorder of the icon arrangement. Therefore, the free position appeared after the movement of the application icon will be filled in time by rearranging the icons in the first area and the second area, without the need to arrange the icons manually by the user. In this technical solution, the predetermined sequence of the arrangement of icons can be any one of the following or a combination thereof: the first letter of the name, the time of installation, and the frequency of use, etc.

In the abovementioned technical solution, preferably, it further comprises: an icon determining unit 714, configured to, when any application icon is dragged to a target position in the first area or the second area, determine an application icon corresponding to the target position in order for said any application icon to occupy a corresponding display position of the determined application icon; wherein, if the target position corresponds to a plurality of application icons, take the application icon arranged at the end as the corresponding application icon; wherein, the icon arranging unit 712 is configured to rearrange other application icons that arranged after the corresponding display position.

In this technical solution, by determining whether there is an application icon in the target position and rearranging after the dragging of the icon, the user can select the display position of the application icon currently being dragged according to needs, and affect the original application icon arrangement as little as possible.

In this technical solution, if the target position corresponds to a plurality of application icons, the application icon arranged at the end will be determined according to a predetermined arrangement sequence of the terminal. For instance, as a preferred embodiment, the arrangement sequence can be as follows: in the horizontal direction, the order of arrangement of the application icons on the left side can be higher than that of the application icons on the right side; in the vertical direction, the order of arrangement of the application icons on the upper side can be higher than that of the application icons on the lower side.

In any of the abovementioned technical solutions, preferably, the touch points can be located in the gap between application icons on the screen interface. By making the touch points in the gap between application icons, erroneous operation due to the overlapping of the touch points and application icons can be avoided, which can be helpful to improve the accuracy of operation.

In accordance with a further aspect of the disclosure, it can be further provided a program product stored in a non-volatile machine readable medium for terminal control. The program product includes machine executable instructions, when executed by a computer system, causing the system to execute the following: detecting multiple touch points formed on a screen interface; displaying a management interface of hidden icons on the screen interface if at least one of the touch points slides to a first direction and at least one of the remaining touch points slides to a second direction opposite to the first direction.

In accordance with a further aspect of the disclosure, it can be further provided a non-volatile machine readable medium storing a program product for terminal control. The program product includes machine executable instructions, when executed by a computer system (such as a system comprises a processor and a memory), causing the system to execute the following: detecting multiple touch points formed on a screen interface; displaying a management interface of hidden icons on the screen interface if at least one of the touch points slides to a first direction and at least one of the remaining touch points slides to a second direction opposite to the first direction.

According to a further aspect of the disclosure, it can be further provided a machine-readable program, configured to cause the machine to execute any of the terminal control methods described in the abovementioned technical solutions.

According to a further aspect of the disclosure, it can be further provided a storage medium storing a machine-readable program. The machine-readable program can be configured to cause the machine to execute any of the terminal control methods described in the abovementioned technical solutions.

The technical solutions of the present disclosure have been described in detail with reference to the drawings, in view of the requirement of switching interfaces repeatedly and the complicated operation, the present disclosure provides a terminal control method and a terminal, by detecting the movement tracks of multiple touch points on the screen interface of a terminal, the management interface of hidden icons can be opened quickly without interface switching, and the operation can be convenient and efficient, thereby improving operational efficiency.

The foregoing descriptions are merely preferred embodiments of the present disclosure, rather than limiting the present disclosure. Various modifications and alterations can be made to the present disclosure for those skilled in the art. Any modification, equivalent substitution, improvement or the like made within the spirit and principle of the present disclosure shall fall into the protection scope of the present disclosure.

What is claimed is:

1. A terminal control method, comprising:
detecting multiple touch points formed on a screen interface; and
displaying a management interface of hidden icons on the screen interface if at least one of the touch points slides to a first direction and at least one of the remaining touch points slides to a second direction opposite to the first direction.

2. The terminal control method of claim 1, wherein the method further comprises:
displaying the contents initially displayed on the screen interface in a first area, and
displaying the management interface of hidden icons in a second area other than the first area on the screen interface.

3. The terminal control method of claim 2, wherein the method further comprises:
determining a display position of the first area or the second area on the screen interface according to the position information of the multiple touch points on the screen interface.

4. The terminal control method of claim 2, wherein the method further comprises:
when any application icon in the first area is dragged into the second area, setting the application icon being dragged into the second area to be a hidden icon from a non-hidden icon; and
when any application icon in the second area is dragged into the first area, setting the application icon being dragged into the first area to be a non-hidden icon from a hidden icon.

5. The terminal control method of claim 4, wherein the method further comprises:
when any application icon is dragged into the first area or the second area, rearranging the application icons in the first area and the second area according to a predetermined sequence.

6. The terminal control method of claim 5, wherein when any application icon is dragged to a target position in the first area or the second area, it further comprises:
determining an application icon corresponding to the target position in order for said any application icon to occupy a corresponding display position of the determined application icon, and rearranging other application icons that arranged after the corresponding display position, wherein, if the target position corresponds to a plurality of application icons, the application icon arranged at the end will be deemed as the corresponding application icon.

7. The terminal control method of claim 1, wherein the touch points are located in the gap between application icons on the screen interface.

8. A terminal control device, comprising:
a touch point detecting unit, configured to detect multiple touch points formed on a screen interface of a terminal;
a slide determining unit, configured to determine whether at least one of the touch points slides to a first direction and at least one of the remaining touch points slides to a second direction opposite to the first direction; and
an interface displaying unit, configured to display a management interface of hidden icons on the screen interface if the determination result of the slide determining unit is yes.

9. The terminal control device of claim 8, wherein the touch points are located in the gap between application icons on the screen interface.

10. The terminal control device of claim 8, wherein the interface displaying unit is configured to:
display the contents initially displayed on the screen interface in a first area; and
display the management interface of hidden icons in a second area other than the first area on the screen interface.

11. The terminal control device of claim 10, wherein the touch points are located in the gap between application icons on the screen interface.

12. The terminal control device of claim 10, wherein the device further comprises:
a position determining unit, configured to determine a display position of the first area or the second area on the screen interface according to the position information of the multiple touch points on the screen interface, wherein the interface displaying unit will display the first area and the second area.

13. The terminal control device of claim 12, wherein the touch points are located in the gap between application icons on the screen interface.

14. The terminal control device of claim 10, wherein the device further comprises:
a hiding setting unit, configured to:
set the application icon being dragged into the second area to be a hidden icon from a non-hidden icon if any application icon in the first area is dragged into the second area; and
set the application icon being dragged into the first area to be a non-hidden icon from a hidden icon if any application icon in the second area is dragged into the first area.

15. The terminal control device of claim 14, wherein the touch points are located in the gap between application icons on the screen interface.

16. The terminal control device of claim 14, wherein the device further comprises:
an icon arranging unit, configured to rearrange the application icons in the first area and the second area according to a predetermined sequence if any application icon is dragged into the first area or the second area.

17. The terminal control device of claim 16, wherein the device further comprises:
an icon determining unit, configured to, when any application icon is dragged to a target position in the first area or the second area, determine an application icon corresponding to the target position in order for said any application icon to occupy a corresponding display position of the determined application icon,
wherein, when the target position corresponds to a plurality of application icons, take the application icon arranged at the end as the corresponding application icon, and
wherein, the icon arranging unit is configured to rearrange other application icons that arranged after the corresponding display position.

18. The terminal control device of claim 8, wherein the touch points are located in the gap between application icons on the screen interface.

19. An apparatus, comprising:
a memory configured to store computer-readable program code; and
a processor configured to invoke the computer-readable program code to execute the following:
detecting multiple touch points formed on a screen interface; and
displaying a management interface of hidden icons on the screen interface if at least one of the touch points slides to a first direction and at least one of the remaining touch points slides to a second direction opposite to the first direction.
